(19) United States
(12) Patent Application Publication
(10) Pub. No.: US 2020/0295640 A1
(43) Pub. Date: Sep. 17, 2020

(54) POWER GENERATION WITH SPEED DEPENDENT MAGNETIC FIELD CONTROL

(71) Applicants: Sebastian Tegeler, Germany (DE); Francesco Quattrone, Germany (DE)

(72) Inventors: Sebastian Tegeler, Germany (DE); Francesco Quattrone, Germany (DE)

(73) Assignee: Baker Hughes Oilfield Operations LLC, Houston, TX (US)

(21) Appl. No.: 16/354,731

(22) Filed: Mar. 15, 2019

(51) Int. Cl. H02K 21/04; H02P 9/10; H02K 3/18; E21B 41/00

(52) U.S. Cl. CPC H02K 21/042; H02P 9/107; H02K 1/2793; E21B 41/0085; H02K 3/18

(57) ABSTRACT

An apparatus for generating electrical power includes a rotor configured to be rotated about a longitudinal axis by fluid flow, the rotor including a plurality of permanent magnets, and a stator including conductor windings and a core. The core includes a conductor assembly having a plurality of conductors that extend axially through the core, the plurality of conductors electrically connected and short-circuited by a conductive connector at each end of the stator. The conductor assembly is configured to limit an induced output voltage to a selected maximum value, and the induced output voltage depends on a rotor speed.

### BACKGROUND

In the resource recovery industry, various downhole tools are employed for purposes such as flow control, drilling, directional drilling and formation property measurements. Examples of such tools include logging-while-drilling (LWD) and measurement-while-drilling (MWD) tools. Some downhole tools generally require electrical power to operate, which can be provided by electrical generators disposed downhole to convert the energy of fluid flowing through a borehole string.

### SUMMARY

An embodiment of an apparatus for generating electrical power includes a rotor configured to be rotated about a longitudinal axis by fluid flow, the rotor including a plurality of permanent magnets, and a stator including conductor windings and a core. The core includes a conductor assembly having a plurality of conductors that extend axially through the core, the plurality of conductors electrically connected and short-circuited by a conductive connector at each end of the stator. The conductor assembly is configured to limit an induced output voltage to a selected maximum value, and the induced output voltage depends on a rotor speed.

An embodiment of a method of generating electrical power includes deploying a power generation assembly in fluid communication with a source of a fluid, the power generation assembly including a rotor configured to be rotated about a longitudinal axis by fluid flow, the rotor including a plurality of permanent magnets. The power generation assembly also includes a stator including conductor windings and a core, where the core includes a conductor assembly having a plurality of conductors that extend axially through the core, the plurality of conductors electrically connected and short-circuited by a conductive connector at each end of the stator. The conductor assembly is configured to limit an induced output voltage of the power generation assembly to a selected maximum value, the induced output voltage depending on a rotor speed. The method also includes rotating the rotor by fluid flow, generating electricity by an interaction between magnetic fields generated by the rotor and the stator, and supplying the electricity to a component.

### BRIEF DESCRIPTION OF THE DRAWINGS

The following descriptions should not be considered limiting in any way. With reference to the accompanying drawings, like elements are numbered alike:

FIG. 1 depicts an embodiment of a system for performing an energy industry operation, the system including a downhole power generator;

FIG. 2 depicts an embodiment of a downhole power generator;

FIG. 3 depicts an example of a section of a stator and a stator core of the power generator of FIG. 2;

FIG. 4 shows an example of a magnetic flux linkage between a stator and a rotor of a permanent magnet generator; and

FIG. 5 is a flow chart for a method for generating electrical power in a downhole environment.

### DETAILED DESCRIPTION

A detailed description of one or more embodiments of the disclosed apparatus and method are presented herein by way of exemplification and not limitation with reference to the figures.

Disclosed are embodiments of apparatuses, systems and methods for generating electrical power in a downhole environment. An embodiment of a power generation assembly includes an alternator or generator having a rotor (e.g., a permanent magnet rotor) and a stator. The stator includes one or more short-circuited conductors disposed therein to provide for field weakening at high rotor speeds. In one embodiment, the one or more short-circuited conductors are configured as part of a squirrel cage assembly including a plurality of axially extending conductors (e.g., aluminum or copper rods or bars) that are embedded or otherwise disposed in a stator core.

Embodiments described herein provide for improved downhole electricity generation, including the ability to supply an at least substantially constant voltage at high speeds and prevent excessive voltage at such high speeds. For example, the short-circuited conductors in the stator weaken the magnetic flux linkage between the rotor and the stator and cause saturation, which restricts the alternator voltage to a voltage threshold. This allows for a relatively steady voltage at high speeds and prevents excessive voltage from developing that could damage the alternator or other components.

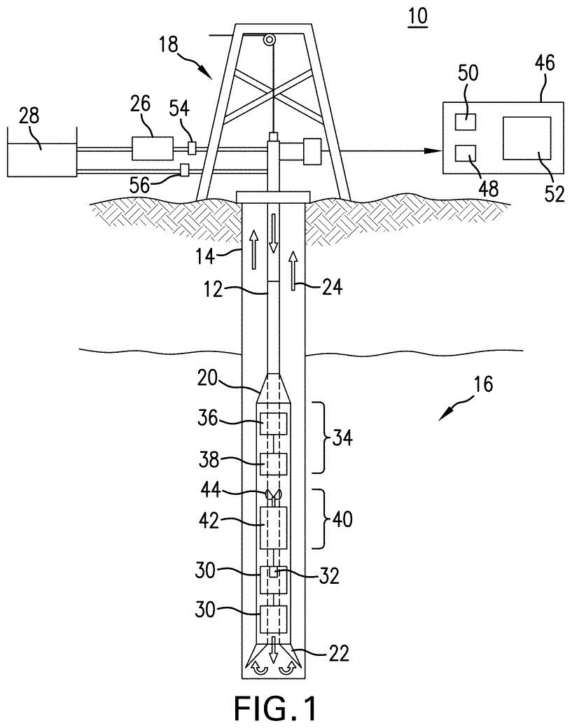

FIG. 1 shows an embodiment of system 10 for performing an energy industry operation (e.g., drilling, measurement, stimulation and/or production). The system 10 includes a borehole string 12 that is shown disposed in a well or borehole 14 that penetrates at least one earth formation 16 during a drilling or other downhole operation. As described herein, “borehole” or “wellbore” refers to a hole that makes up all or part of a drilled well. It is noted that the borehole 14 may include vertical, deviated and/or horizontal sections, and may follow any suitable or desired path. As described herein, “formations” refer to the various features and materials that may be encountered in a subsurface environment and surround the borehole 14.

The borehole string 12 is operably connected to a surface structure or surface equipment 18 such as a drill rig, which includes or is connected to various components such as a surface drive or rotary table for supporting the borehole string 12, rotating the borehole string 12 and lowering string sections or other downhole components. In one embodiment, the borehole string 12 is a drill string including one or more drill pipe sections that extend downward into the borehole 14, and is connected to a bottomhole assembly (BHA) 20.

The BHA 20 includes a drill bit 22, which in this embodiment is driven from the surface, but may be driven from downhole, e.g., by a downhole mud motor. The surface equipment 18 includes components to facilitate circulating fluid 24 such as drilling mud through the borehole string 12 and an annulus between the borehole string 12 and the borehole wall. For example, a pumping device 26 is located at the surface to circulate the fluid 24 from a mud pit or other fluid source 28 into the borehole 14 as the drill bit 22 is rotated.

In the embodiment of FIG. 1, the system 10 shown is configured to perform a drilling operation, and the borehole string 12 is a drill string. However, embodiments described herein are not so limited and may have any configuration suitable for performing an energy industry operation that includes a downhole power generator. For example, the system 10 may be configured as a stimulation system, such as a hydraulic fracturing and/or acidizing system.

The system 10 may include one or more of various tools 30 configured to perform selected functions downhole such as performing downhole measurements, facilitating communications, performing stimulation operations and/or performing production operations. For example, one or more of the downhole tools 30 may include one or more sensors 32 for performing measurements such as logging while drilling (LWD) or measurement while drilling (MWD) measurements.

In one embodiment, the system 10 includes a telemetry assembly 34 such as a mud pulse telemetry (MPT), for communicating with the surface and/or other downhole tools or devices. The telemetry assembly 34 includes a pulser 36 that generates pressure signals through the fluid, and an actuator 38.

Some downhole components, such as the tools 30 and/or the telemetry assembly 34, need electrical power to operate. Such power can be transmitted from the surface via a cable, or provided by a downhole power generation system as discussed herein.

The system 10, in one embodiment, includes a downhole power generation assembly 40. The power generation assembly 40 includes an alternator 42 coupled to a turbine 44 (also referred to as a mud turbine) that is rotated by drilling mud or other fluid circulating through the drill string 12.

In one embodiment, one or more downhole components and/or one or more surface components may be in communication with and/or controlled by a processor such as a downhole processor and/or a surface processing unit 46. In one embodiment, the surface processing unit 46 is configured as a surface control unit which controls various parameters such as rotary speed, weight-on-bit, fluid flow parameters (e.g., pressure and flow rate) and others.

The surface processing unit 46 (and/or the downhole processor 40) may be configured to perform functions such as controlling drilling and steering, controlling the flow rate and pressure of borehole fluid, transmitting and receiving data, processing measurement data, and/or monitoring operations of the system 10. The surface processing unit 46, in one embodiment, includes an input/output device 48, a processor 50, and a data storage device 52 (e.g., memory, computer-readable media, etc.) for storing data, models and/or computer programs or software that cause the processor to perform aspects of methods and processes described herein.

Surface and/or downhole sensors or measurement devices may be included in the system 10 for measuring and monitoring aspects of an operation, fluid properties, component characteristics and others. In one embodiment, the surface processing unit 42 and/or the downhole processor includes or is connected to various sensors for measuring fluid flow characteristics. For example, the system 10 includes fluid pressure and/or flow rate sensors 54 and 56 for measuring fluid flow into and out of the borehole 14, respectively. Fluid flow characteristics may also be measured downhole, e.g., via fluid flow rate and/or pressure sensors in the drill string 12.

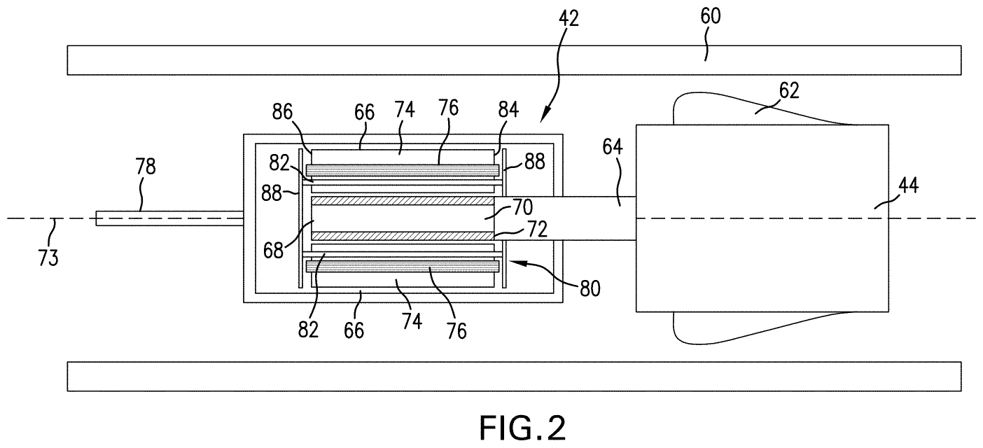

FIG. 2 depicts aspects of an embodiment of the downhole power generation assembly 40. The power generation assembly 40 may be incorporated into the drill string 12 as part of a power generation module or sub, or incorporated as part of a component or tool to supply power to thereto.

For example, the power generation assembly 40 is disposed in a housing 60, which may be a housing for a power generation module or a housing for a downhole component such as the BHA 20. The housing 60 includes one or more fluid channels, so that drilling mud or other fluid circulating through the drill string 12 turns blades 62 on the turbine 44.

The turbine 44 is mechanically connected to the alternator 42, for example, by a drive shaft 64. Other components may be included to facilitate a mechanical connection between the turbine 44 and the alternator 42. For example, a clutch device such as a magnetic clutch is disposed between the turbine 44 and the alternator 42.

The alternator 42 includes a rotor 68 and a stator 66 that surrounds the rotor 68. In one embodiment, the alternator is configured as a permanent magnet synchronous machine with a multiphase winding topology, sometimes referred to as a permanent magnet generator (PMG). In this embodiment, the rotor includes a rotor yoke 70 and a plurality of permanent magnets 72 that extend along a longitudinal axis 73 of the alternator 42, the power generation assembly 40 and/or the drill string 12. In one embodiment, the rotor 68 includes a plurality of permanent magnets with alternating magnetization directions, which are distributed around the rotor yoke 70.

It is noted that, although embodiments described herein include a stator that surrounds a rotor, the embodiments are not so limited. For example, in one or more embodiments, the alternator 42 includes a rotor that surrounds a stator.

The stator 66 includes a ferromagnetic stator core 74 and conductor windings 76. As the rotor 68 rotates, a magnet field generated by the magnets 72 interacts with the magnetic field produced by the windings 76 and generates a voltage (an induced output voltage) in the windings 76 of the stator 66 in order to provide electrical power. The electrical power is provided to a tool via any suitable connection mechanism, such as an electrical connector 78. In one or more embodiments, the generated electrical energy is three-phase alternating current.

The alternator 42 is driven by the turbine 44, which is in turn rotated by fluid flow through the drill string 12 and the power generation assembly 40. During an energy industry operation, such as drilling, stimulation or completion operation, the characteristics of fluid flow such as flow rate and pressure can potentially vary widely during. Such variation in fluid flow can present challenges to typical alternators due to the speed-voltage properties of such alternators. For example, the speed-voltage characteristic of a standard permanent magnet (PM) alternator is approximately linear, which leads to a voltage range that is almost proportional to flow rate. Where there is a wide flow spread (i.e., wide range of flow rates), a typical alternator can exhibit a correspondingly wide voltage range, which can cause problems with electronic circuits and safety issues associated with high voltage conditions.

The power generation assembly 40 includes features that address the above challenges. In one embodiment, the stator 66 includes a conductor assembly 80 having one or more conductors 82 that are fixedly disposed within or on the stator core 74 and that extend axially along the alternator 42. An “axially extending” conductor refers to a conductor whose length extends at least partially parallel with the axis 73. For example, each conductor 82 may extend parallel to the axis 73 or at an angle with respect to the axis 73.

At least two conductors 82 may be connected at the ends of the stator core and short-circuited, so that a current is generated in each conductor 82 during operation of the alternator 42. In one embodiment, the conductor assembly 80 includes a plurality of short-circuited axially extending conductors 82 that are electrically connected at or near each end of the stator core 74, e.g., in a squirrel cage configuration.

For example, as shown in FIG. 2, a plurality of conductors 80, such as copper or aluminum bars or rods, extend axially through the stator 66 and are short-circuited at or near a first end 84 and a second end 86 of the stator core 74. The conductors are short-circuited via any suitable connector, such as by conductive rings 88. The conductive rings 88 may be made from any suitable electrically conductive material, such as aluminum or copper.

The conductors 82 may be arranged or disposed on or in the stator 66 in any suitable manner. For example, the conductors 82 are circumferentially arranged on or in the stator core 74, and inserted into a conduit formed on or inside the stator core 74. Examples of such conduits include axial passages or holes formed within the stator core 74 and axial grooves or depressions formed at a surface of the stator core 74. Furthermore, the conductors 82 may be wire bundles, solid bars, solid rods or other elongated members that are disposed in or on the stator core 74, may be conductive materials embedded or deposited into the stator core 74, or may have any other desired configuration.

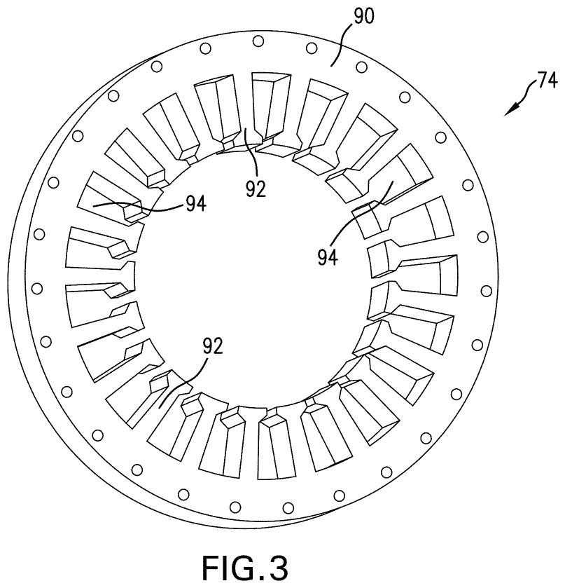

FIG. 3 shows a section of an embodiment of the stator core 74 and illustrates exemplary features of the stator core 74 that can be used to dispose conductors therein. In this embodiment, the stator core 74 is formed as a cylindrical body from steel or iron laminations. The stator core 74 includes a body portion or yoke 90 and an array of posts or teeth 92. The teeth 92 may be used to support the windings 76. In one embodiment, the conductors 82, such as aluminum bars, are inserted through one or more gaps 94 between the teeth 92. In another embodiment, the conductors 82 are inserted through holes or passages in the yoke 90.

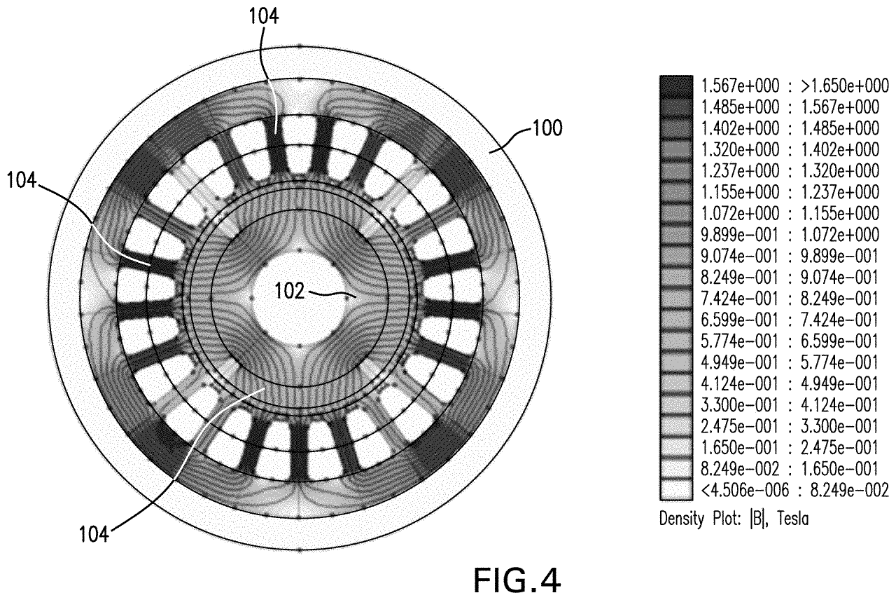

As noted above, the conductor assembly 80 acts to weaken the magnetic flux linkage between a rotor and a stator and cause saturation at high rotor speeds. FIG. 4 shows the magnetic flux linkage between a stator 100 and a rotor 102 in a conventional alternator arrangement, which is shown by flux lines 104. The distance between flux lines 104 reflects the flux density.

The conductor assembly 80 acts to weaken this linkage and restrict the induced output voltage to a maximum value at high speeds (e.g., 7000 RPM and greater) to overcome the linear relationship between speed and voltage that would otherwise be exhibited. As fluid flow and correspond rotor speed increases, a higher damping current will flow through the conductors 82, which leads to a distortion of the alternator's magnetic fields. This distortion brings a lower flux linkage to the stator windings 76 and therefore a lower voltage on the alternator 42.

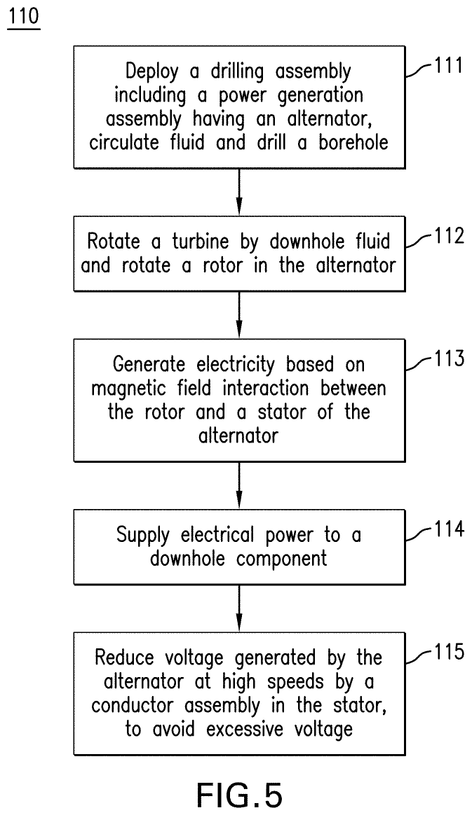

FIG. 5 illustrates a method 110 of performing an energy industry operation and generating power for one or more downhole components. The method 110 may be used in conjunction with the system 10, although the method 110 may be utilized in conjunction with any suitable type of device or system for which downhole electrical power is desired. The method 110 includes one or more stages 111-115. In one embodiment, the method 110 includes the execution of all of stages 111-115 in the order described. However, certain stages may be omitted, additional stages may be added, and/or the order of the stages may be changed.

In the first stage 111, the drill string 12 is deployed and the borehole 14 is drilled to a desired location or depth. During drilling, borehole fluid 24 is pumped through the drill string 12 and the BHA 20.

In the second stage 112, borehole fluid 24 flowing through the drill string 12 rotates the turbine 44 and thereby rotates the rotor 68.

In the third stage 113, interaction between the magnetic field generated by magnets in the rotor 68 and the magnetic field generated by the stator windings 76 produces a voltage. Due to the fact that the conductors 82 are short-circuited, this voltage induces a current in the conductors 82.

In the fourth stage 114, electrical power is supplied to a desired downhole component (e.g., the telemetry assembly 34).

In the fifth stage 115, when fluid flow increases and the rotor speed consequently increases, current in the conductors 82 increases. At high rotor speeds (e.g., 7000 RPM and greater), this current leads to an additional field with a ˜180° phase shift to the origin field. This pushes the origin field towards the center of the alternator 42, which leads to a lower amount of field that is linked with the windings 76. Consequently, the alternator voltage is limited to some threshold maximum value.

Embodiments described herein provide a number of advantages and technical benefits. For example, an alternator having a conductor assembly as described herein (e.g., a squirrel cage assembly) acts to reduce the voltage spread over wide flow ranges, and reduces the amount of voltage on the alternator at high rotor speeds. This reduction is beneficial for downhole electronics and reduces risks associated with high voltages. In addition, the alternator is able to restrict the voltage to a maximum value at high speed conditions.

The embodiments provide these benefits without the need for complex electronics that are conventionally used to actively control the alternator voltage. This allows for, e.g., a generator that can operate in a fluid flow range that is approximately 30% greater than that for conventional alternators.

Set forth below are some embodiments of the foregoing disclosure:

Embodiment 1: An apparatus for generating electrical power, the apparatus including a rotor configured to be rotated about a longitudinal axis by fluid flow, the rotor including a plurality of permanent magnets; and a stator including conductor windings and a core, wherein the core includes a conductor assembly having a plurality of conductors that extend axially through the core, the plurality of conductors electrically connected and short-circuited by a conductive connector at each end of the stator, the conductor assembly configured to limit an induced output voltage to a selected maximum value, the induced output voltage depending on a rotor speed.

Embodiment 2: The apparatus as in any prior embodiment, wherein the apparatus is configured to supply power to a downhole component and further comprises a turbine that is mechanically connected to the rotor, the turbine configured to be rotated by downhole fluid.

Embodiment 3: The apparatus as in any prior embodiment, wherein the rotor and the stator are disposed in a housing configured to be disposed in a borehole, the housing including one or more fluid conduits, the turbine configured to be rotated by fluid circulated through the borehole and the one or more fluid conduits.

Embodiment 4: The apparatus as in any prior embodiment, wherein the conductor assembly is configured to limit the induced output voltage and supply an at least substantially constant amount of the induced output voltage at rotor speeds that exceed a threshold speed.

Embodiment 5: The apparatus as in any prior embodiment, wherein the conductor assembly is configured as a squirrel cage, and each conductive connector is a conductive ring disposed at or near an end of the stator core.

Embodiment 6: The apparatus as in any prior embodiment, wherein the plurality of conductors are circumferentially arrayed around the longitudinal axis.

Embodiment 7: The apparatus as in any prior embodiment, wherein each conductor is a solid bar made from an electrically conductive material.

Embodiment 8: The apparatus as in any prior embodiment, wherein the stator core includes a plurality of circumferentially arrayed teeth configured to support conductor windings, and each conductor of the plurality of conductors is disposed within a gap between adjacent teeth.

Embodiment 9: The apparatus as in any prior embodiment, wherein the stator surrounds the rotor.

Embodiment 10: The apparatus as in any prior embodiment, wherein each conductor of the plurality of conductors is disposed within an elongated conduit formed in a yoke of the stator core.

Embodiment 11: A method of generating electrical power, the method includes deploying a power generation assembly in fluid communication with a source of a fluid, the power generation assembly including: a rotor configured to be rotated about a longitudinal axis by fluid flow, the rotor including a plurality of permanent magnets; and a stator including conductor windings and a core, wherein the core includes a conductor assembly having a plurality of conductors that extend axially through the core, the plurality of conductors electrically connected and short-circuited by a conductive connector at each end of the stator, the conductor assembly configured to limit an induced output voltage of the power generation assembly to a selected maximum value, the induced output voltage depending on a rotor speed; and rotating the rotor by fluid flow, generating electricity by an interaction between magnetic fields generated by the rotor and the stator, and supplying the electricity to a component.

Embodiment 12: The method as in any prior embodiment, wherein the power generation assembly is configured to supply the electricity to a downhole component, and rotating the rotor includes rotating a turbine by downhole fluid, the turbine mechanically connected to the rotor.

Embodiment 13: The method as in any prior embodiment, wherein the rotor and the stator are disposed in a housing configured to be disposed in a borehole, the housing including one or more fluid conduits, and rotating the rotor includes rotating the turbine by downhole fluid flowing through the one or more fluid conduits.

Embodiment 14: The method as in any prior embodiment, wherein the conductor assembly is configured to limit the induced output voltage and supply an at least substantially constant amount of the induced output voltage at rotor speeds that exceed a threshold speed.

Embodiment 15: The method as in any prior embodiment, wherein the conductor assembly is configured as a squirrel cage, and each conductive connector is a conductive ring disposed at or near an end of the stator core.

Embodiment 16: The method as in any prior embodiment, wherein the plurality of conductors are circumferentially arrayed around the longitudinal axis.

Embodiment 17: The method as in any prior embodiment, wherein each conductor is a solid bar made from an electrically conductive material.

Embodiment 18: The method as in any prior embodiment, wherein the stator core includes a plurality of circumferentially arrayed teeth configured to support conductor windings, and each conductor of the plurality of conductors is disposed within a gap between adjacent teeth.

Embodiment 19: The method as in any prior embodiment, wherein the stator surrounds the rotor.

Embodiment 20: The method as in any prior embodiment, wherein each conductor of the plurality of conductors is disposed within an elongated conduit formed in a yoke of the stator core.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. An apparatus for generating electrical power, the apparatus comprising:
a rotor configured to be rotated about a longitudinal axis by fluid flow, the rotor including a plurality of permanent magnets; and
a stator including conductor windings and a core, wherein the core includes a conductor assembly having a plurality of conductors that extend axially through the core, the plurality of conductors electrically connected and short-circuited by a conductive connector at each end of the stator, the conductor assembly configured to limit an induced output voltage to a selected maximum value, the induced output voltage depending on a rotor speed.

2. The apparatus of claim 1, wherein the apparatus is configured to supply power to a downhole component and further comprises a turbine that is mechanically connected to the rotor, the turbine configured to be rotated by downhole fluid.

3. The apparatus of claim 2, wherein the rotor and the stator are disposed in a housing configured to be disposed in a borehole, the housing including one or more fluid conduits, the turbine configured to be rotated by fluid circulated through the borehole and the one or more fluid conduits.

4. The apparatus of claim 1, wherein the conductor assembly is configured to limit the induced output voltage and supply an at least substantially constant amount of the induced output voltage at rotor speeds that exceed a threshold speed.

5. The apparatus of claim 1, wherein the conductor assembly is configured as a squirrel cage, and each conductive connector is a conductive ring disposed at or near an end of the stator core.

6. The apparatus of claim 1, wherein the plurality of conductors are circumferentially arrayed around the longitudinal axis.

7. The apparatus of claim 6, wherein each conductor is a solid bar made from an electrically conductive material.

8. The apparatus of claim 1, wherein the stator core includes a plurality of circumferentially arrayed teeth configured to support conductor windings, and each conductor of the plurality of conductors is disposed within a gap between adjacent teeth.

9. The apparatus of claim 1, wherein the stator surrounds the rotor.

10. The apparatus of claim 1, wherein each conductor of the plurality of conductors is disposed within an elongated conduit formed in a yoke of the stator core.

11. A method of generating electrical power, the method comprising:
deploying a power generation assembly in fluid communication with a source of a fluid, the power generation assembly including:
a rotor configured to be rotated about a longitudinal axis by fluid flow, the rotor including a plurality of permanent magnets; and
a stator including conductor windings and a core, wherein the core includes a conductor assembly having a plurality of conductors that extend axially through the core, the plurality of conductors electrically connected and short-circuited by a conductive connector at each end of the stator, the conductor assembly configured to limit an induced output voltage of the power generation assembly to a selected maximum value, the induced output voltage depending on a rotor speed; and
rotating the rotor by fluid flow, generating electricity by an interaction between magnetic fields generated by the rotor and the stator, and supplying the electricity to a component.

12. The method of claim 11, wherein the power generation assembly is configured to supply the electricity to a downhole component, and rotating the rotor includes rotating a turbine by downhole fluid, the turbine mechanically connected to the rotor.

13. The method of claim 12, wherein the rotor and the stator are disposed in a housing configured to be disposed in a borehole, the housing including one or more fluid conduits, and rotating the rotor includes rotating the turbine by downhole fluid flowing through the one or more fluid conduits.

14. The method of claim 11, wherein the conductor assembly is configured to limit the induced output voltage and supply an at least substantially constant amount of the induced output voltage at rotor speeds that exceed a threshold speed.

15. The method of claim 11, wherein the conductor assembly is configured as a squirrel cage, and each conductive connector is a conductive ring disposed at or near an end of the stator core.

16. The method of claim 11, wherein the plurality of conductors are circumferentially arrayed around the longitudinal axis.

17. The method of claim 16, wherein each conductor is a solid bar made from an electrically conductive material.

18. The method of claim 11, wherein the stator core includes a plurality of circumferentially arrayed teeth configured to support conductor windings, and each conductor of the plurality of conductors is disposed within a gap between adjacent teeth.

19. The method of claim 11, wherein the stator surrounds the rotor.

20. The method of claim 11, wherein each conductor of the plurality of conductors is disposed within an elongated conduit formed in a yoke of the stator core.
